(19) United States
(12) Patent Application Publication
(10) Pub. No.: US 2022/0040773 A1
(43) Pub. Date: Feb. 10, 2022

(54) HOLE SAW FOR USE WITH AN OSCILLATING MULTI-TOOL

(71) Applicant: VLADAN KRSTIC, PALM HARBOR, FL (US)

(72) Inventor: VLADAN KRSTIC, PALM HARBOR, FL (US)

(21) Appl. No.: 17/223,015

(22) Filed: Apr. 6, 2021

Related U.S. Application Data
(60) Provisional application No. 63/007,322, filed on Apr. 8, 2020.

(51) Int. Cl. B23D 61/00; B27B 19/00; B23D 61/12

(52) U.S. Cl. CPC B23D 61/006; B23D 61/121; B27B 19/006

(57) ABSTRACT

The objects of the present invention are achieved in a hole saw for cooperation with an associated oscillating tool having an output shaft that sequentially moves clockwise and counterclockwise and the output shaft includes a 1st drive interface coupling to the driveshaft which includes a cylindrical body having an axis and 1st and 2nd axial extremities; a 2nd drive interface fixed to a 1st axial extremity of the cylindrical body. The 2nd drive interface is dimensioned and configured for coupling clockwise and counterclockwise rotational movement of the 1st drive interface to the 2nd drive interface whereby the cylindrical body sequentially rotates clockwise and counterclockwise. Each of a plurality of teeth extend from the 2nd axial extremity of the body. Each of the teeth have 1st and 2nd opposed sharpened edges.

### CROSS-REFERENCE TO RELATED APPLICATIONS

This application relies on the priority of U.S. provisional patent application 63/007,322 filed Apr. 8, 2020.

### TECHNICAL FIELD

The present invention is generally directed to tools utilized in the construction industry. More particularly, the present invention is directed to oscillating multi-tools and tools cooperating therewith. Even more particularly, the present invention is directed to a saw to be used in construction or whenever it is desired to cut a circular shaped opening or any part of a given circular opening in, for example, wood or drywall as well as many types of plastic, ceramic or metal.

### BACKGROUND OF THE INVENTION

The present invention provides a solution for the problem encountered in both construction and wherever else it is desired to cut a circular shaped opening or any part of the circle on any of a wide variety of materials.

Often in construction work and other situations it is desired to fit, for example, a sheet of material such as drywall, plywood, or any other material that can be used in construction next to a circle shaped object, or to build around the object when two sheets are needed to join and make a perfect fit around that cylindrical object or simply to make a larger hole over existing smaller hole.

Using a conventional hole saw is not possible in these situations since they can make only full circle holes and require a solid surface for engaging a center guide bit. Workers that use the prior art hole saws have difficulties mounting or dismounting the prior art hole saw having at least three pieces: (1) hole saw, (2) mounting arbor and (3) center drill bit. After use, it is often very difficult to disassemble these pieces because the continuing rotation in one direction causes the arbor and hole saw to mutually lock together. Very often this occurs while working on a high ladder where drilling a hole with the conventional tool requires both hands of the user. If the hole saw catches an obstacle like screw or nail the user's wrist may be twisted causing the user to lose balance and to initiate serious injury.

Prior art hole saws can cut only by repetitive 360° movement and have teeth sharpened only on one side of each tooth. In addition, prior art hole saws require an arbor and a center drill bit in order to make a cut and they need to be assembled and tightened with a key and channel locks pliers or wrenches. The center piece usually has a welded hardened steel nut cooperating with an arbor to mount the assembly on a drill.

From the above, it is therefore seen that there exists a need in the art to overcome the deficiencies and limitations described herein and above.

### SUMMARY OF THE INVENTION

The shortcomings of the prior art are overcome and additional advantages are provided with a hole saw for cooperation with an associated oscillating tool having an output shaft that sequentially moves clockwise and counterclockwise and the output shaft includes a 1st drive interface coupling to the driveshaft which includes a cylindrical body having an axis and 1st and 2nd axial extremities; a 2nd drive interface fixed to a 1st axial extremity of the cylindrical body. The 2nd drive interface is dimensioned and configured for coupling clockwise and counterclockwise rotational movement of the 1st drive interface to the 2nd drive interface whereby the cylindrical body sequentially rotates clockwise and counterclockwise. A plurality of teeth extends from the 2nd axial extremity of the body. Each of the teeth have 1st and 2nd opposed sharpened edges.

Each pair the 1st and 2nd opposed sharpened edges of each tooth define a plane. Each cross section of the cylindrical body taken in a plane perpendicular to the axis define a circle. Each intersection of each such plane and each such circle defining a chord of a defined circle.

In some embodiments of the hole saw each of the plurality of teeth are identical. Each tooth edge may be cut at a 30° angle. Each of the teeth may have a chamfered edge on the inside face of each tooth which may be a chamfered edge is 30°.

It is an object of the present invention to provide a tool that can be operated with one hand.

It is another object of the present invention to enable the user to cut 360° circular pieces or parts thereof.

It is yet another object of the present invention to facilitate cutting by enabling a user to more safely complete cutting.

It is a still further object of the present invention to enable cutting of circular part or a part of a circular part when it is not possible to use a centering drill.

It is still another object of the present invention to provide apparatus that minimizes safety risks inherent in a conventional unidirectional drill. More specifically, for example, the danger when performing a cutting procedure when on a ladder or performing cutting operation that potentially can, for example, break the wrist of the user.

Additional features and advantages are realized through the techniques of the present invention. Other embodiments and aspects of the invention are described in detail herein and are considered a part of the claimed invention.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is an isometric view of a prior art battery operated multi-tool illustrating a typical drive interface for cooperation with a variety of tools such as the hole saw in accordance with the present invention.

FIG. 2 is an isometric view of an embodiment of a hole saw in accordance with the present invention.

FIG. 3 is a sectional view taken along the line A-A of FIG. 4.

FIG. 4 is a top view of one embodiment of the hole saw in accordance with the present invention illustrating the contours of openings in the back of the hole saw that are dimensioned and configured for engagement with the drive surfaces shown on the multi-tool illustrated in FIG. 1

FIG. 5 is a side view of the hole saw in accordance one embodiment of the present invention.

FIG. 6 is an enlarged detail view of an inside part of several teeth identified in FIG. 3 by the letter A which are representative of the inside part of all of the teeth.

FIG. 7 is an enlarged detail view of an outside part of several teeth identified in FIG. 5 by the letter B which are representative of the inside part of all of the teeth.

### DETAILED DESCRIPTION

The oscillating multi-tool is a problem solver when you need to make difficult cuts in wood or metal, especially those that occur in a tight spot. The tool helps you undercut door jambs, make removal cuts in baseboard trim, cut notches in flooring, make surgical cuts in drywall or, worse, lath and plaster. This type of tool also sands and grinds into corners and peels caulk off a surface. With a carbide grit grinding pad, it can remove grout or Thinset mortar.

The tool accomplishes all this with a sturdy horizontal motor that brings power to a gear box that reorients the motor's rotational force 90 degrees and converts it into an oscillating movement with a sweep of only a few degrees side to side. That unusual movement is harnessed to a tool-free chuck to mount fine-tooth saw blades, triangular-shaped sanding or grinding pads, putty knife blades and a variety of other attachments that vary by manufacturer. Typically, respective manufacturers tend to differentiate their tools with a unique mechanical interface on the oscillating tool that meshes and cooperates with an interface on an individual tool. Most, if not all individual tools are elongated and have, for example, an elongated shape having a first axial extremity coupled to the oscillating tool and a second axial extremity that, for example, has teeth for cutting a piece of wood.

Such oscillating multi-tools typically have a drive shaft that that is coupled to tool extending radially from the drive shaft. The oscillating tool works by moving the tool head side to side very quickly—up to 20,000 times a minute.

The present invention is a hole saw 22 that uses the oscillating power of the oscillating multi-tool 10. This combination does not need the center guide required by conventional hole saws.

The hole saw in accordance with the present invention mounts directly on the oscillating multi-tool tool without previous preparation. This contrasts with a conventional hole saw that requires assembling an arbor with a center drill bit and a hole saw in order to mount the assembly on a drill driver.

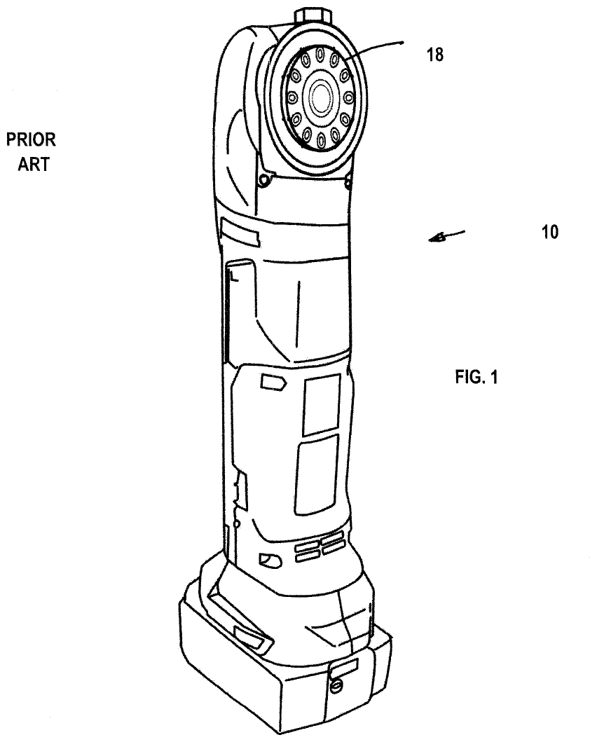

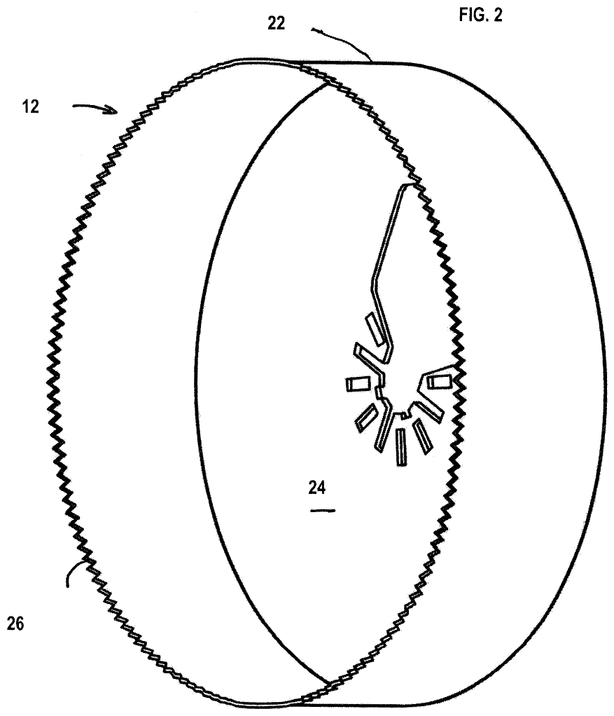

FIG. 1 illustrates a prior art oscillating tool 10. Such a multi-tool 10 powers the hole saw 12 in accordance with the present invention.

The direct connection of the hole saw 12 with engagement plate 18 fixed to an output shaft (not shown) the oscillating tool 10 causes the hole saw 12 to sequentially rotate clockwise and then counterclockwise.

The illustrated embodiment of the hole saw 12 has a cylindrical wall 22 and a planar circular back 24 fixed to a 1st axial extremity of the wall 22. The 2nd axial extremity of the cylindrical wall includes a plurality of teeth 26 extending generally parallel to the geometric axis cylindrical wall 22 and away from the back 24.

The back 24 includes a recess 28 dimensioned and configured to receive one or more drive faces of a multitool 10. More particularly the recess 28 is dimensioned and configured, for example, to engage the engagement plate 18 of the multi-tool 10. Other hole saws in accordance with the present invention may use other engaging surfaces dimensioned and configured to mate with other brands of multitools.

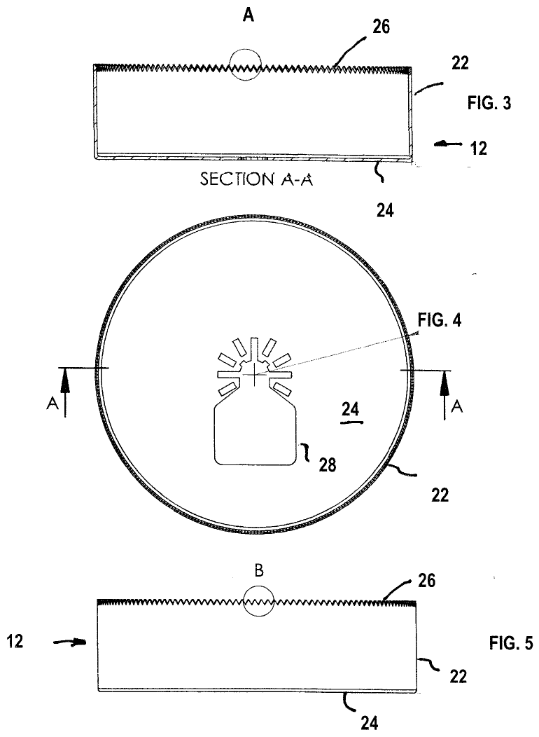

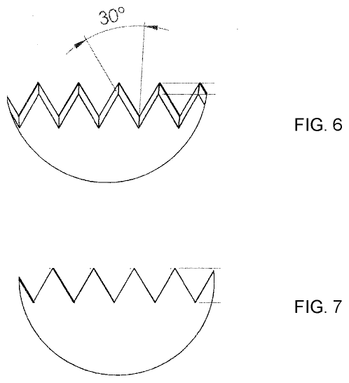

FIG. 3 is a sectional view taken along the line A-A of FIG. 4. Accordingly, the illustration of the teeth 26 in FIG. 3 is an illustration of the teeth taken from the inside of the hole saw 22. Similarly detail A marked in FIG. 3 and shown in FIG. 7 still better illustrates the contour of the inside surface of the teeth 26.

FIG. 5 is a side view of the hole saw 12 in accordingly shows the outside surface of the teeth 26. The detail B marked in FIG. 5 is illustrated in greater detail in FIG. 7.

The hole saw 12 may have 155 teeth uniformly spaced along the 2nd axial extremity of the hole saw 12. As indicated in the drawing the teeth are cut at a 30° angle and a chamfered edge at 30° is present only on the inside edge of each tooth.

The teeth 26 are double sharpened, meaning each tooth has first and second opposed sharp edges. This double sharpened tooth construction is particularly desirable because this configuration insures a sharp leading edge both during clockwise and counter clockwise movement. The chamfered interior edge minimizes binding of the hole saw 26.

Typically, the hole saw 12 in accordance with the present invention can be mounted on the oscillating tool without any tool such as an Allen Wrench or other wrench.

Although the drawings and description above describe a hole saw 12 having openings in the back 24 that mesh with the multi-tool 10, it will be understood that that a separate plate having the required hole pattern may be bolted on the back if the hole saw 12. This approach requires less inventory for sales distribution channels and may facilitate use by contractors or other users who may have multiple multi-tools.

Embodiments of the present oscillating hole saw are manufactured from hardened steel with thin walls and cutting teeth sharpened from both sides to enable progressive cutting since the tool oscillates substantially left-right. Because the movement of the drive shaft is so small, the characterization of the movement as being substantially left-right is justified. Embodiments of the present hole saw are to be made from hardened steel, bi-metal, titanium, carbide, or any other hard material that can meet expectations in order to cut desired material with minimum wear and provide durability of the saw for many uses. The center piece of the tool is made to fit on any multi tool brand manufacturer and with cutting teeth designed in such a way to provide effective cuts for designated material. Those skilled in the art will recognize the nature of the required interface between the oscillating tool and the individual tool that is coupled to the oscillating tool as described with respect to FIG. 4.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A hole saw for cooperation with an associated oscillating tool having an output shaft that sequentially moves clockwise and counterclockwise and the output shaft includes a 1st drive interface coupling to said driveshaft which comprises:
a cylindrical body having an axis and 1st and 2nd axial extremities
a 2nd drive interface fixed to a 1st axial extremity of the cylindrical body, said 2nd drive interface being dimensioned and configured for coupling clockwise and counterclockwise rotational movement of said 1st drive interface to said 2nd drive interface whereby said cylindrical body sequentially rotates clockwise and counterclockwise; and
a plurality of teeth extending from said 2nd axial extremity of said body, each of said teeth having 1st and 2nd opposed sharpened edges, each pair of said 1st and 2nd opposed sharpened edges of each tooth defining a plane,
each cross section of said cylindrical body taken in a plane perpendicular to the axis defining a circle;
each intersection of each such plane and each such circle defining a chord of a defined circle.

2. The hole saw as described in claim 1 wherein each of said plurality of teeth are identical.

3. The hole saw as described in claim 1 wherein each tooth edge is cut at a 30° angle.
